(19) United States
(12) Patent Application Publication
(10) Pub. No.: US 2005/0017514 A1
(43) Pub. Date: Jan. 27, 2005

(54) Laminar flow, suction driven, wind energy conversion

(76) Inventor: Angus J. Tocher, Calgary (CA)

Correspondence Address: David F. Zinger;SHERIDAN ROSS P.C., Suite 1200, 1560 Broadway, Denver, CO, 80202-5141, US

(21) Appl. No.: 10/625,953

(22) Filed: Jul. 23, 2003

(51) Int. Cl. F03D 9/00; H02P 9/04

(52) U.S. Cl. 290/55

(57) ABSTRACT

A laminar flow, suction driven, wind energy conversion device is disclosed for extracting usable energy from wind. The device includes multiple vacuum generators that react with the wind flow to generate usable vacuum. The device avoids the use of potentially hazardous, high speed and exposed rotor or turbine blades of popular wind energy conversion devices and may therefore be safely located within human and animal habitats. The device incorporates many useful and novel features including a pneumatic transmission that the vacuum generators use to drive turbines to produce usable energy from wind energy, a framework that integrates components of the invention into a single structure, a method to cause the framework and components to self-orient into the oncoming wind, valves to manage the non-uniform distribution of vacuum pressures within the device that are caused by turbulent wind flow, and secondary airflow accelerators that serve to maintain an acceptably laminar flow of wind through the venturi-like openings within the device.

### FIELD OF THE INVENTION

The present invention relates to using wind energy and, in particular, converting wind energy into useful energy employing venturi principles.

### BACKGROUND OF THE INVENTION

Conversion of the kinetic energy in a moving mass of air into mechanical energy by use of a venturi, or venturi tube, is very old. The basic operation of the carburetion system of an internal combustion engine uses the vacuum produced in the throat of a venturi, as air is drawn into the engine, to draw fuel and mix it in correct proportions with air drawn into the engine cylinders.

Similar venturis were used extensively, mounted on the fuselages of airplanes, to provide a source of suction to drive aircraft gyro instruments such as the turn and bank indicator and the directional gyro. A National Advisory Committee for Aeronautics paper entitled “Performance Characteristics of Venturi Tubes Used in Aircraft for Operating Air-Driven Gyroscopic Instruments” (November 1937), evaluates several different venturi tube designs used for this application. It is also common practice to couple two or more venturi tubes together. This is often done with where it is desirable to join the suction lines of multiple venturi tubes to provide additional vacuum flow to one or more aircraft gyro instruments.

Venturis continue to be used in many jet pump applications as a simple means to mix liquids in a flow, or to meter the flow of liquids. The 1972 study by J. A. C. Kentfield and R. W. Barnes for the Institution of Mechanical Engineers entitled “The Prediction of the Optimum Performance of Ejectors”, is an example of more modern studies of vacuum producing venturi devices. Regardless of the application, all vacuum producing venturi devices have certain common characteristics. All use Bernoulli's principles that relate the acceleration of a primary fluid flow and a corresponding drop in static pressure, and all have a secondary entrained or mixed flow of a liquid or gas into the primary flow. The vacuum producing venturi device is a very well understood and relatively simple device for developing and delivering a source of vacuum or suction.

The use of venturis has also been suggested for wind energy conversion devices. On page 33 of “Wind Machines”, second edition (1980), by Frank R. Eldridge, in a chapter titled “Taxonomy”, there appears an illustration of a venturi tube, identical in principle to the aircraft venturi tube, that also shows a ram air feed leading to a turbine or impellor, and then supplying a source of air to the vacuum region of the venturi tube. No further reference is made in this book of a venturi type wind energy converter.

In a wind flow, the most common application of Bernoulli's principles is the aircraft wing. It is this same acceleration of a wind flow over the top cambered surface of a wing that generates the vacuum that is largely responsible for the development of lift. U.S. Pat. No. 5,709,419 entitled “Wind Energy Collection” to Roskey (1998) is an example of a vacuum producing venturi device used in such a wind flow. This patent teaches a device that includes the characteristic elements common to all vacuum producing venturi devices including the acceleration of a primary airflow by an airfoil, resultant development of lower static air pressure, and entrainment of a secondary airflow to harness the produced vacuum.

In this example, rather than driving aircraft gyro instruments, the device is larger with the intent to drive a turbine and electrical generator or alternator. Roskey's device as well joins the vacuum lines proceeding from the secondary airflow outlets that border the venturi spacings. This is identical to the joining of the vacuum lines of multiple aircraft venturis to drive the turbine of a single gyroscopic instrument.

It is important to note that aircraft venturis operate in a very steady and constant stream of wind. The wind in this case is generated by the forward motion of the aircraft and therefore the individual venturis are not subject to the erratic changes in velocities that often occur in winds, and especially those in near proximity to the ground. The erratic behavior of wind, or turbulence, may seriously affect the performance of vacuum producing venturi systems, including the device of Roskey, that have not been adapted to compensate for these negative effects. The principle adverse effect of wind turbulence in vacuum producing wind energy conversion devices is the development of non-uniform vacuums both on different areas of the airfoils in close proximity to the secondary airflow outlets, and even between different airfoils of the device. These non-uniform static air pressures are a direct result of the differing wind speeds and directions present in turbulent wind flows. When uncorrected, the result is that vacuum flow, rather than being drawn from the turbine, may be drawn from a neighboring region of the same secondary airflow outlet or from different secondary airflow outlets as their vacuum lines are joined together. This will have the direct effect of de-powering the turbine and seriously reduce energy conversion efficiency. It is an object of the present invention to correct this deficiency in the prior art. It is also an object of the present invention to provide means to cause the airfoils or venturis to self-orient as a group, into the oncoming wind flow. No such means for this is proposed by the device of Roskey. Additionally, it is an object of the present invention to integrate dynamic or ram sources of air to the turbines, or energy converters within the device. The integration of these ram air sources into the structure of the device of the present invention serves to increase wind energy conversion efficiency and serves to assist in the self-orientation of the device into the oncoming wind flow. Neither of these two advantages are proposed or anticipated by the device and patent of Roskey.

U.S. Pat. No. 6,239,506 entitled “Wind Energy Collection System”, also to Roskey (2001), teaches certain improvements to the airfoil design of the previously cited patent and device. One improvement consists of “an airfoil formed from a tubular member with a circular cross-section and a substantially planar leading edge”. This patent of Roskey also claims particular mechanical means for individually aligning the airfoils into the wind. These improvements do not address the important issues, as previously described, relating to the management of wind energy conversion losses caused by a non-uniform distribution of static air pressures encountered in turbulent winds, nor the issues relating to the supply of a ram intake source of air, the integration of elements of the device into a common structure, or the issue of self-orientation of the device as a whole into the oncoming wind. A further deficiency that is not discussed in either of the two cited patents of Roskey relates to the importance of maintaining a smooth or laminar flow of air over the airfoils, or vacuum generating elements of a venturi device. The direct entrainment of a secondary airflow from the airfoil edge nozzles, or secondary airflow outlets or Roskey's devices will disrupt and cause an early separation of the laminar flow of wind over the cambered surfaces of the airfoils and dramatically reduce wind energy conversion efficiency, just as the early separation of the laminar airflow over an aircraft wing results in a stalled condition and dramatic loss of lift. It is an object of the present invention to draw and smoothly accelerate the secondary airflow into the venturis in such a way as to minimize the disruption of the laminar airflow over the vacuum generating surfaces within the venturi and thereby optimize the energy conversion efficiency of the venturi-like device of the present invention. Roskey teaches as well certain attachments to the vacuum producing airfoils such as concentrators and secondary airfoils termed “mini-sails” that are claimed as novel and used presumably to reduce this described effect.

A third example of a vacuum or suction driven wind energy conversion device is U.S. Pat. No. 4,963,761 entitled “Wind-Driven Power Generator”, to Wight (1990). This is a device that includes “roof members” that are formed in such a way as to accelerate a flow of wind from any compass direction and thereby create a vacuum or suction to turn the impellers of a turbine. The device of Wight is claimed to also be useful as pavilion shelters when located in parks or picnic areas. In addition to other aesthetic qualities, the device of Wight has certain other advantages over conventional rotor driven or vertical axis wind energy conversion systems including safety, as the turbine elements are located within the device, and simplicity, as the device is able to utilize winds coming from all compass directions without the need to orient the device into the wind. As well, Wight claims that the roof members of the device are stackable so that a larger frontal area or “wave front” of the wind may be utilized. No clear description however is provided as to how these stacks are able to share a single turbine as suggested. A main disadvantage of the device of Wight is the use of abundant amounts of roof materials where only a limited amount of this material may be functional in the conversion of wind energy into usable energy for any particular direction of wind. It may however be argued that this additional material serves to provide shelter in inclement weather. Wight does not discuss the issues relating to wind turbulence and it is therefore questionable whether or not the device is functionally sound particularly in conditions of turbulent winds.

U.S. Pat. No. 5,040,948 entitled “Coaxial Multi-Turbine Generator”, to Harburg (1991), and U.S. Pat. No. 5,969,430 entitled “Dual Turbine Wind/Electricity Converter”, to Forrey (1999), are examples of wind energy conversion devices that use multiple wind assemblies to capture the energy latent in wind, and multiple alternators or generators to convert this energy into usable electrical energy. The use of multiple wing assemblies has the advantage of increasing the frontal area of wind captured without the use of large diameter, expensive and potentially more hazardous rotor blades, but does so with the compromise of high component cost and maintenance. A major advantage of the device of the present invention is that it allows the utilization of large frontal wind areas without the expense and maintenance associated with the use of numerous alternators, generators, turbines and related mechanical and electrical components.

U.S. Pat. No. 4,449,053 entitled “Vertical Axis Wind Turbine”, to Kutcher (1984) provides a good example of a Darrieus, or vertical-axis wind energy conversion system. Vertical axis systems have achieved some commercial success but have now largely been replaced by highly evolved rotor type wind energy conversion systems. The most noted advantage of the vertical-axis system is its symmetry and therefore inherent ability to utilize winds from all compass directions. Additionally, vertical-axis systems are generally large and able to capture relatively large frontal areas of wind. Disadvantages of vertical-axis systems include issues of stability and the slowing or braking of the turbines necessary in high wind speed conditions, the requirement of guy wires to support the turbine and resultant larger use of land area, and as well the difficulty of mounting such systems up and away from the ground and associated turbulence and slower winds. As well, the dangers associated with high speed and sometimes failing turbine blades restrict the locating of such devices to remote areas. Finally, U.S. Pat. No. 6,361,275 entitled “Wind Energy Installation”, to Wobben (2002) provides an example of certain improvements made to a rotor type wind energy conversion system, the type most popular and widely deployed for the commercial production of electricity at the present time. The principal advantages that are responsible for the commercial success of the rotor type system have much to do with its long history of development from the farm windmills, that were used extensively to pump water for domestic livestock, to their adaptation to limited electricity production, and finally to the types used in the modern day wind farm. Additionally, rotor type systems of sound design are elegant in their apparent simplicity, have generally simple and well tested means for orienting the rotor blades into the wind, are mounded on tall columns or structures to capture smoother and faster winds, and are generally considered aesthetically pleasing. The disadvantages of rotor wind energy conversion systems are less well known to the public in general but include a distinctive hazard to wildlife and in particular to rarer birds of prey that hunt mice and other rodents that flourish within the grassy areas of wind farms that now use the rotor type of wind energy converters almost exclusively. Many other disadvantages of this increasingly popular wind energy conversion system are discussed in greater detail in the Objects and Advantages section of this application for patent. It is a particular object of the device of the present invention to offer solutions to the many deficiencies of rotor type systems that at the present time limit the use of wind energy as a serious alternative to other forms of commercial electricity production that pollute the environment or introduce new risks to human or animal life.

### SUMMARY OF THE INVENTION

The present invention is directed towards a vacuum driven wind energy conversion device comprising one or more vacuum generators, the vacuum generators having aerodynamic surfaces for accelerating the flow of wind and thereby inducing regions of vacuum; one or more vacuum outlets located in proximity to the regions of vacuum that provide sources of air to be drawn into the regions of vacuum; one or more energy converters to convert the force of air drawn into the regions of vacuum into usable electrical or mechanical energy; one or more intake collectors to supply sources of air or ram air to the energy converters; one or more vacuum channels for supplying air to one or more vacuum outlets and to one or more regions of vacuum, and for conveying air from the energy converters, and additionally, one or more of the following:

A framework used to support and integrate the elements of the invention into a single structure and an arrangement of the elements of the invention mounted on the framework, and an aerodynamic framework design, such that the force of wind acting on the elements or on the framework causes the framework and elements to orient appropriately into the oncoming wind.

One or more flow regulator valves used to prevent or reduce a reverse flow of air into, rather than out of, one or more vacuum outlets that may otherwise occur under turbulent conditions of wind flow, or to manage, limit or otherwise control the flow of air outwards from the vacuum outlet means and into the regions of vacuum.

A venturi design that includes one or more secondary airflow accelerators formed around one or more vacuum outlets and having aerodynamic surfaces such that wind flowing around the aerodynamic surfaces of the secondary airflow accelerators will be accelerated to a lesser degree than that of wind flowing around the aerodynamic surfaces of an adjacent vacuum generator, the two forming a venturi spacing through which wind flows, and such that air drawn out of the vacuum outlet will be accelerated more gradually and smoothly into the venturi spacing than would occur without such a venturi design, and such that wind flowing over the aerodynamic surfaces of the vacuum generator within the venturi spacing will be more laminar than without such a venturi design.

Further objects and advantages of the present invention will become apparent from consideration of the following description and accompanying drawings.

Accordingly, it is the object of the present invention to provide a wind energy converter device that includes one or more of the following objects and advantages:

1. Safety and resultant suitability of installation within human or animal habitat.

To provide a wind energy converter device that by omission of high speed rotor or turbine blades, lessens the risk to humans, animals and wildlife. Of particular reference is wildlife such as raptors, or birds of prey that have a tendency to so focus on the object of prey that they frequently attempt to fly through and are struck by the high speed rotor or turbine blades of popular forms of wind energy converter devices. As well, the blades of these forms of wind energy converters may fail and cause injury to people and animals in the vicinity. This is a factor that limits there usage to isolated locales or wind farms. This is also a leading factor, as well as vibration, that preclude the mounting of these types of devices on top of high rise buildings that could otherwise provide excellent locations for wind energy converter devices. These limitations do not exist for the device of the present invention as no such high speed rotor blades are included or are uncovered so as to pose such a risk. There is little possibility for birds to fly into the energy converters of the device of the present invention as they are internal to the structure of the device and, for the same reason, there is little possibility that the energy converters, generally as enclosed turbines, could fail and impose a hazard to human or animal life. As such, and for further reasons that will be described, the wind energy converter of the present invention is suitable for installation in close proximity to human and animal habitats and is particularly suitable for installation atop man-made high rise structures used as domiciles or commercial offices and workplaces.

2. Low vibration and resultant suitability of installation within human or animal habitat.

In addition to the issue of safety as described in (1), a further advantage of the present invention relating to the installation of same within human or animal habitats is provided by virtue of its inherent low vibration. As most popular wind energy converter devices operate well within a turbulent airflow and relatively close to the ground, large asymmetric forces are imposed upon the high speed rotors or turbine blades of these devices and are transmitted through the rotor or turbine blades and into the supporting structures. Because of this, it is not practical to mount these devices on top of high rise buildings as the vibrations would be experienced; felt or heard; by the occupants of the building. This is a further important factor that limits or precludes the installation of popular wind energy converter devices atop man-made inhabited structures. As will be understood in the following sections of this application, the present invention inherently provides in essence a pneumatic transmission that buffers and virtually eliminates these types of vibrations that originate in the turbulent airflow layers in which wind energy converters generally operate.

3. Utilization and conversion of higher speed, higher energy winds.

Popular wind energy converters may have large rotor blade diameters of up to 40 meters or even greater. Generally these large commercial wind energy converters are limited to a maximum wind energy usage equivalent to about 25 miles per hour wind speed. This means that even when wind speeds exceed about 25 mph, the maximum energy that the rotor driven wind energy converter is able to convert to mechanical or electric energy is no greater than that obtainable in a 25 mph wind. This does not mean that the rotor device is unable to operate in winds exceeding 25 mph. The technical rational for this limitation relates to issues of mechanical loading on the rotor blades, rotor bearings and related mechanical structures given that this loading increases as the square of increasing wind speeds and airflow turbulence. In the end, it is an issue of design and production costs versus returns as it relates to the accommodation of higher wind speeds and associated increases in airflow turbulence. The present invention does not suffer from this limitation to the degree suffered by rotor or turbine driven wind energy converters. The reason for this is that the present invention utilizes a fundamentally different method for the conversion of wind energy that employs directly the principles of differential static pressures according to the renown Bernoulli's equations, and avoids the requirement for large diameter rotor or turbine blades that directly experience the mechanical loading and mechanical shock of higher speed winds and airflow turbulence. As such, and for reasons that will be more fully disclosed in following sections of this application, the present invention will tolerate, and more, convert the kinetic energy provided by higher wind speeds and airflow turbulence into usable mechanical or electrical energy.

4. Efficiency of operation in turbulent wind conditions.

Prior art venturi or vacuum driven devices, especially those that use multiple venturi devices suffer vacuum losses under conditions of turbulent wind; wind with varying speeds and directions. The result of this turbulence is to produce local variations of vacuum pressures within a single venturi, and between individual venturis. Unless otherwise prevented or reduced, the effect is that areas of higher vacuum pressure may draw air from the locales of lower vacuum pressure either within a particular venturi, or from a nearby interconnected venturi, rather than applying the vacuum pressure onto the turbine or energy converter device. It is a substantial object of the present invention to provide a means to eliminate or greatly reduce these potential losses and thereby enable the device to more efficiently extract energy from higher speed and often associated higher turbulence winds.

5. Self-contained and self-directing wind energy converter.

Prior art venturi or vacuum driven devices having multiple venturi devices do not provide a means to contain all of the elements including the turbines or energy converter devices within a single integrated structure. No means therefore is provided, in the prior art, to direct the venturis of these devices, as a group, into the oncoming wind. It is an important object of the present invention to provide a means to integrate most or all of the components of the present invention into a single integrated structure and as well to provide an overall aerodynamic design such that the entire structure will self-orient appropriately into the oncoming wind solely by the action of the wind upon the device. Although such means is provided by many conventional rotor type wind energy converters, such means is not suggested or proposed by the prior art for vacuum driven or venturi type wind energy converters.

6. Provision of integrated ram air intakes into a vacuum driven or venturi type wind energy converter.

It is an object of the present invention to integrate such ram air intakes into the common structure of the present invention for at least the following reasons:
a) To cause the ram air intakes to self-align into the oncoming wind along with the venturis and the common supporting structure.
b) To provide a ram source of air to the turbines or energy converter units in order to increase the wind energy conversion efficiency of the present invention.
c) To position the ram air intakes within the common structure such that the aerodynamic forces of drag of the ram air intakes assist with the appropriate alignment of the present invention into the oncoming wind.

7. Reduction of design, production and operational costs and expenses.

All of the aforementioned objects and advantages of the present invention translate into a reduction of initial capital investment and operational costs of production for embodiments of the present invention. The advantage of safety to human and animal life means that the present invention may be used in a wide variety of locations and situations without the necessity of purchase or lease of large tracts of isolated land for wind farms. This inherent safety advantage also relates directly to a reduction of public insurance premiums and liabilities. The omission of rotor or turbine blades and associated mechanisms that are needed to increase the pitch of the rotor blades necessary to withstand the forces of higher wind speeds and airflow turbulence translates to significantly reduced initial capital costs as well as reduced maintenance costs. Rotor braking and the limiting of rotor or turbine speeds necessary for rotor or vertical-axis type wind energy converters represent additional significant contributing factors to the high costs of these devices. The ability of the present invention to utilize wind speeds higher than generally usable by rotor or vertical-axis wind energy converters provides a more efficient utilization of the kinetic energy available in these higher wind speeds. This ability of the present invention over-rides the opinion or criticism that venturi-type devices have relatively high energy conversion losses at lower wind speeds. Given the fact that the kinetic energy available in wind is proportional to the cube of the wind speed, a general statement may be made that it is of greater value that a wind energy converter device have the ability to extract energy from winds of higher speed that those of lower speed, assuming that suitable locations of installation have been chosen. It is proposed therefore that a well engineered embodiment of the object of the present invention will provide a greater ratio of energy output to capital investment and operational costs than that provided by popular rotor or vertical-axis type wind energy converter designs currently in use.

### BRIEF DESCRIPTION OF THE DRAWINGS

FIG. 1 is a perspective view from front and below of one embodiment of the invention;

FIG. 2 provides a perspective view from front and above of several components of an embodiment of the invention and components that constitute the pneumatic transmission of the present invention;

FIG. 3 is a perspective view from above and in front of embodiments of one of the intake collector elements, of one of the energy converter elements, and of one of the intake channels of the present invention;

FIG. 4 is a perspective view from above and in back of embodiments of two of the vacuum generator elements and embodiments of other related components of the present invention;

FIG. 5 is a perspective view from above and in back of an additional embodiment of the invention that includes an embodiment of a secondary airflow accelerator element;

FIG. 6 includes two perspective views from above and in back of embodiments of components of the present invention. The view on the left illustrates embodiments of a vacuum channel and flow regulator element having closed flow regulator valves, and the view on the right illustrates the same elements with open flow regulator valves;

FIGS. 7 and 8 are schematic plan views used to illustrate airflow and aerodynamic principles of possible embodiments of the invention and include means for vacuum generators, secondary airflow accelerators and vacuum outlets of the present invention; and

FIG. 9 illustrates both plan and perspective views of one embodiment of the present invention. The top right perspective view from below and in back illustrates an embodiment of the directional pivot element and method of self-orientation of the present invention.

### DETAILED DESCRIPTION

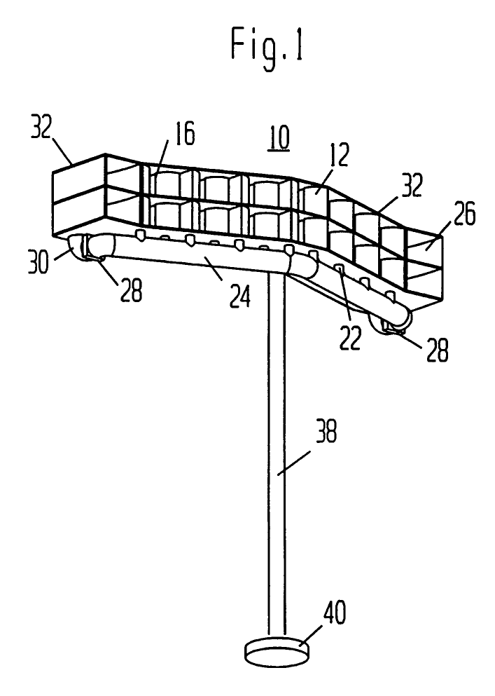

FIG. 1 illustrates one embodiment of present invention 10. Also illustrated in FIG. 1 are various embodiments of functional elements of invention 10 including the following: Vacuum generator 12 is a device similar to the top surface of a cambered wing that causes the impinging wind flow to accelerate thus forming a relatively lower static air pressure than the ambient static air pressure of the wind flowing around and past invention 10. This pressure differential is exploited by invention 10 so as to extract kinetic energy from the wind and convert it to usable mechanical or electrical energy. Intake collector 26 is a device that collects and supplies a preferable positive relative static pressure air supply to energy converter 28 and ultimately to vacuum outlet 16. Energy converter 28 consists generally of a turbine driven by airflow supplied by intake collector 26 and airflow drawn by vacuum produced primarily by vacuum generator 12. Intake channel 30, such as a pipe, conveys the supply of air provided by intake collector 26 to energy converter 28. Vacuum channel 22 such as pipes, connects and supplies air to vacuum outlet 16. Vacuum collector 24, such as a large diameter pipe relative to vacuum channel 22, provides and conveys a common source of air to vacuum channels 22, and combines the vacuum generated by various vacuum generators 12. Vacuum collector 24 as well serves to collect and concentrate the vacuum generated by the various vacuum generators 12 upon energy converter 28. Also illustrated is framework 32 to support and integrate elements of invention 10 into a single structure. Also apparent from FIG. 1 is an arrangement of various elements of invention 10 on framework 32, and a design of framework 32 such as to cause the collection of vacuum generators 12 and intake collector 26 to face the oncoming wind flow. Riser 38 is used to raise the collection of vacuum generators 12 and intake collectors 26 up and into the freer flowing wind. Foundation 40 represents an anchoring base for invention 10 on riser 38.

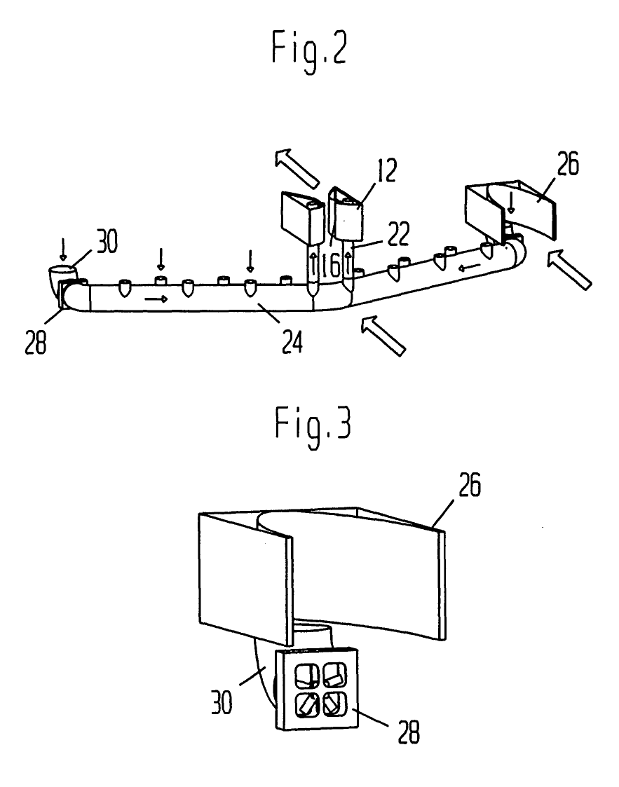

FIG. 2 provides an extracted view of several components of invention 10 that are involved in the conveyance of air entering intake collectors 26 and traveling, as indicated by the smaller arrows, via intake channels 30, through energy converters 28, along vacuum collector 24 and vacuum channels 22 and drawn out of vacuum outlets 16 and into an area of vacuum produced by the action of vacuum generators 12 with the oncoming wind flow, as indicated by the larger arrows, mixing with the wind flow, and finally exiting the venturi spacing along with the wind flow.

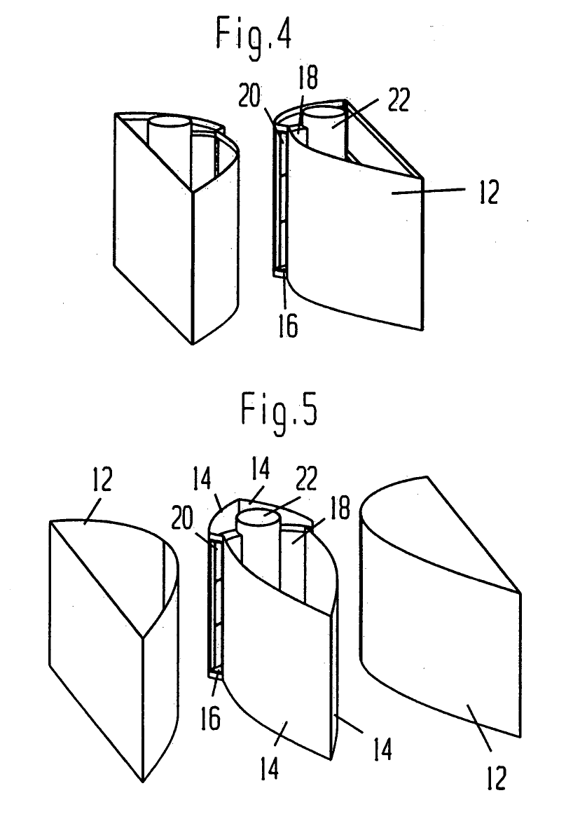

FIG. 3 illustrates embodiments of an intake collector 26, intake channel 30 and energy converter 28. Intake collector 26 serves to collect and direct a preferably ram air source from the wind flow impinging upon intake collector 26 into intake channel 30 and energy converter 28 respectively. Intake channel 30, illustrated in this embodiment of invention 10, is an angled pipe, and energy converter 28 also illustrated consists of a housing with airflow openings on intake and outlet sides, and mounted turbine with associated generator or alternator. This illustration depicts the conversion of wind energy to usable electrical energy by energy converter 28. Many other methods will be recognized by those skilled in the art for converting wind energy into usable electrical or mechanical energy by energy converter 28, but generally use some form of turbine that reacts with a flow of air. It is also important to state that although the subject of the present invention relates to the conversion of wind energy to usable mechanical or electrical energy, the fundamental principles relate to fluid dynamics, air considered to be a fluid, and therefore apply as well to other forms of fluid and in particular to water. The application therefore of the principles disclosed and as well the novel claims of this application for patent apply to air and as well to other forms of fluids. For clarity and to avoid any confusion in the disclosure, the term air will continue to be used to represent the action of a fluid with invention 10.

FIG. 4 illustrates two of vacuum generators 12 arranged as a mirror imaged pair, as well as other associated elements. The arrangement of the two illustrated vacuum generators 12 will be recognized by those skilled in the art of fluid dynamics as forming a venturi spacing used to accelerate the flow of air or other fluids. Also illustrated is vacuum outlet 16 to port airflow from vacuum channel 22 and into an area of lower relative static air pressure generated by vacuum generators 12. Flow regulator valves 20 are also indicated in an open position. Flow regulator valve 20 ensures a unidirectional flow of air outwards from vacuum outlet 16 into the wind flow passing by vacuum generator 12, and prevents or limits the reverse flow of air into vacuum outlet 16. Flow regulator 18 is also indicated to supply a flow of air from vacuum channel 22 and into a region of vacuum.

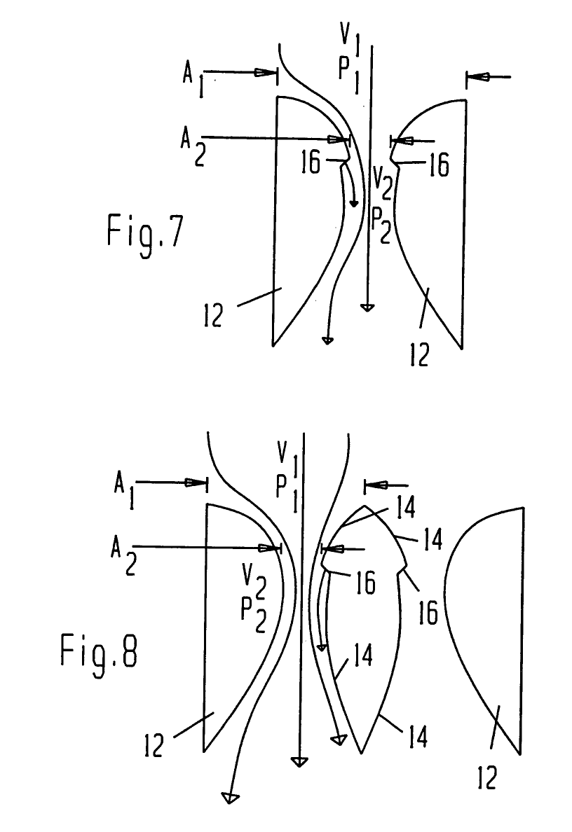

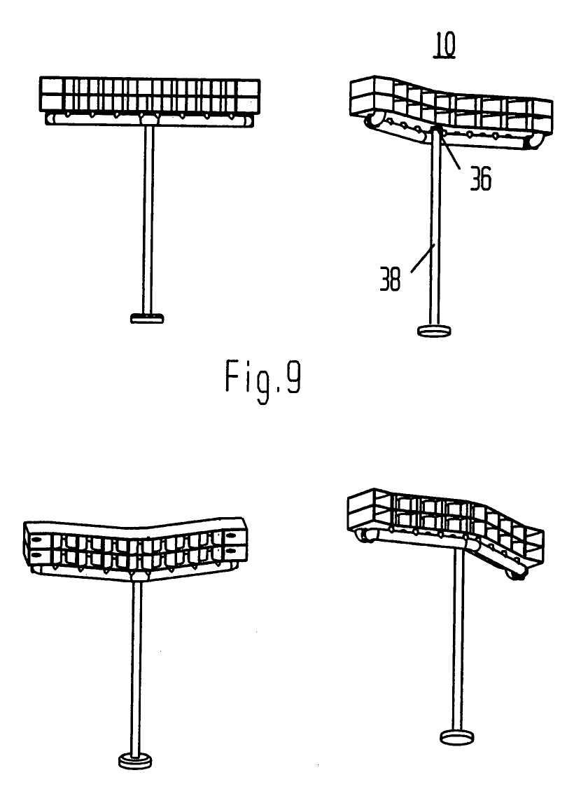

FIG. 5 also illustrates a pair of vacuum generators 12 along with associated elements. In this instance, vacuum outlet 16, flow regulator valves 20, flow regulators 18 and vacuum channel 22 are located separately from vacuum generators 12 as illustrated. Secondary airflow accelerator 14 forms around vacuum outlet 16 and has aerodynamic surfaces suitable to enable the air flowing out of vacuum outlet 16 to have a smooth or relatively laminar flow around these aerodynamic surfaces. One embodiment, as indicated, shows aerodynamic surfaces formed such that they cause the wind flow to accelerate, or develop vacuum, to a lesser degree than the adjacent vacuum generator 12 within the same venturi spacing. As will be understood by those skilled in the art of fluid dynamics, it is important that the wind flow over the aerodynamic surfaces of vacuum generator 12 and of secondary airflow accelerator 14 remains attached or laminar as long as possible to attain maximum efficiency of the venturi device. This principle will be further discussed and clarified in the descriptions of FIGS. 7 and 8.

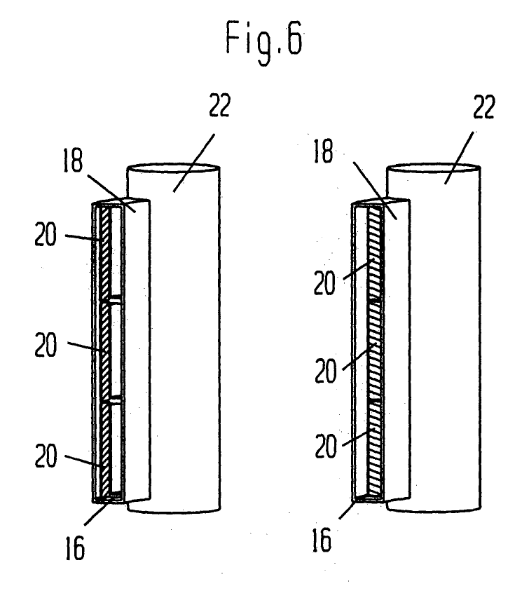

FIG. 6 provides two views of embodiments of vacuum outlet 16, flow regulator 18, flow regulator valves 20, and vacuum channel 22. The left hand illustration of FIG. 6 shows three of flow regulator valves 20 in an extreme wide open position allowing air to be drawn out of vacuum channel 22 and out of vacuum outlets 16 and into an area of relative low static air pressure generated by vacuum generator 12 and as well, depending on the aerodynamic design, by secondary airflow accelerator 14. Hatching is used in these illustrations of embodiments of flow regulator valve 20 to more clearly represent the positions of these embodiments. The right hand illustration shows the same three flow regulator valves 20 in an extreme closed position and preventing or limiting a flow of air in a reverse direction to that described. Although the function of flow regulator valves 20 is to prevent a reverse flow of air as described, flow regulator valves 20 may assume intermediate positions between fully open or fully closed to limit the flow of air outwards in the correct direction as described, and may as well operate independently from each other such that for the current example of FIG. 6, the center flow regulator valves 20 may be in an open position, and the two outside flow regulator valves 20 may be in closed or partially closed positions depending on the relative static air pressures and aerodynamic and mechanical forces present.

FIG. 7 provides a two dimensional schematic of two mirror imaged embodiments of vacuum generators 12 and vacuum outlets 16 of invention 10. This drawing includes arrows used schematically to indicate the general flow of air or wind between two of vacuum generators 12 and out of vacuum outlets 16, and as well includes labels A₁, V₁, and P₁, respectively the frontal area, velocity and static pressure of the wind flow at the entrance to the area between the two illustrated vacuum generators 12. The labels A₂, V₂ and P₂ represent respectively the frontal area, accelerated velocity and correspondingly reduced static air pressure of the wind flow at the narrowed area between the two illustrated vacuum generators 12. For clarity of the illustration, arrows indicating airflow or wind flow are provided only for the center and left hand side of the venturi spacing.

FIG. 8 also provides a plan schematic view of two mirror imaged embodiments of vacuum generators 12, as well as two vacuum outlets 16 with associated secondary airflow accelerators 14 as described. Arrows are again used to represent air or wind flow past the aerodynamic surfaces of vacuum generators 12 and of secondary airflow accelerators 14 and past vacuum outlets 16. For clarity, arrows indicating air or wind flow in FIG. 8 are provided only for the left venturi spacing as illustrated. It is emphasized that the curvature of the surfaces illustrated for vacuum generators 12 and of secondary airflow accelerators 14 are for purpose of illustration only and do not necessarily represent curvatures of appropriate aerodynamic design. Relatively however, it may be noted that the illustrated curvatures of surfaces of secondary airflow accelerators 14 are less than those of vacuum generators 12. These relative different curvatures are applied to lessen the separation of laminar airflow within the venturi spacing, as previously described, that may otherwise occur as airflow exits vacuum outlet 16 and is accelerated by the wind flow passing by vacuum generator 12 and vacuum outlet 16. The labels of A₁, V₁, P₁ and A₂, V₂, P₂ apply as in FIG. 7 with the exception that the venturi of note may be considered to form between vacuum generator 12 and secondary airflow accelerator 14, rather than between two of vacuum generators 12. FIG. 8 therefore illustrates two such venturis with the aforementioned labels applying to the venturi formed on the left hand side of FIG. 8. These labels will be used in a proceeding section to provide a description of the basic operation of a venturi and further disclosure of invention 10.

FIG. 9 provides a variety of views of embodiments of invention 10. The top right hand view is provided to illustrate one example of directional pivot 36, and riser 38. Apparent in the lower right hand view in this illustration is a layout of components of invention 10 and in particular of the array of vacuum generators 12 and intake collectors 26 that cause these elements, along with framework 32 to self-orient into the oncoming wind flow. Directional pivot 36 facilitates this self-orientation.

Invention 10 is a type of vacuum or suction driven wind energy conversion device. As preferred embodiments of invention 10 include at least two vacuum generators 12, or at least one vacuum generator 12 and one secondary airflow accelerator 14 oriented with respect to each other to form a venturi spacing through which wind may flow, the fundamental operation of invention 10 may be described in terms familiar to those skilled in the art by referring to aerodynamic principles that apply to venturi systems. This simplification provides a necessary foundation for the description of the operation of invention 10 provided in this section.

Referring therefore to FIG. 7, invention 10 is oriented such that wind is caused to flow directly into and between the spacing between a pair of vacuum generators 12 having at least one vacuum outlet 16 through which air may be drawn in to an area of relative low static air pressure, or vacuum produced by wind flowing around and being accelerated by vacuum generator 12. In FIG. 8, two venturi spacings may be considered to form, one between the left hand vacuum generator 12 and opposing secondary airflow accelerator 14, and another between the right hand vacuum generator 12 and opposing secondary airflow accelerator 14. Secondary airflow accelerator 14 has the functions of assisting in the maintenance of a suitably laminar flow of wind over vacuum generator 12 and secondary airflow accelerator 14, to provide a suitable aerodynamic path for the wind to flow past vacuum outlet 16, and as well to facilitate the acceleration and mixing of air drawn out of vacuum outlet 16 and into the wind flow. The frontal area of the wind entering the spacing between either the two vacuum generators 12 of FIG. 7, or the vacuum generator 12 and secondary airflow accelerator 14 of FIG. 8, is indicated by the label A₁ representing not a linear separation distance, but a two dimensional area. The second dimension is depth or height of the venturi spacing and for clarity of the illustrations, this dimension is assumed but not shown by the plan schematic views of FIGS. 7 and 8. Just prior to entering the venturi spacing A₁, the wind flow will have some measurable velocity V₁, and static pressure P₁. As the wind flows around the aerodynamic entrance surfaces formed between vacuum generators 12 or between vacuum generator 12 and secondary airflow accelerator 14, the spacing narrows to a frontal area of wind flow indicated by the label A₂. Within this area, the wind flow velocity indicated by V₂ increases relative to V₁, and the corresponding static air pressure P₂ decreases relative to P₁ at the entrance. It is this relative difference in static air pressures P₂ and P₁ that creates a potential flow of air from within vacuum outlet 16 into the lower static air pressure areas in the vicinity of the narrowed spacing. It will also be noticed by those skilled in the art of fluid dynamics that these principles apply as well in this example even where only one vacuum generator 12 is present and directed in a similar fashion so that wind will be caused to accelerate around the aerodynamic entrance surface of vacuum generator 12. The arrangement of vacuum generators 12 and secondary airflow accelerators 14 are suggested by FIGS. 7 and 8 as practical means for maximizing the frontal area exposed to the oncoming wind thereby maximizing the wind energy available for conversion, and as well for utilizing the aerodynamic benefits of a venturi style arrangement of vacuum generators 12 and secondary airflow accelerator 14. An additional and significant advantage to this suggested arrangement is that the chord distance, or that distance parallel with the direction of wind flow through the venturi spacing, is minimized. Minimizing the chord distance of the venturi spacing and maximizing the frontal area exposed to the wind flow by the use of multiple smaller venturis, rather than fewer larger venturis, allows the minimum use of material by embodiments of invention 10.

With reference to FIGS. 7 and 8 therefore, a calculation can be made to relate A₁, V₁, and P₁ to A₂, V₂ and P₂ and to determine the theoretical maximum possible differential in static air pressures P₁ and P₂. The mathematics of fluid dynamics can be complicated especially in the case of venturi devices having mixing secondary airflows. The mathematical relationships provided herein are therefore limited to demonstrating a maximum potential static air pressure differential (P₂-P₁). The calculation is further simplified by assuming a zero flow of air from vacuum outlets 16. Therefore, by the continuity equation or the law of conservation of mass as it applies to fluid flow:
A₁V₁=A₂V₂

Relating static air pressure to wind flow velocity and assuming a constant air density (D) generally allowed for wind speeds below about 200 mph, by Bernoulli's equations:
P₁+½DV₁²=P₂+½DV₂²
Re-arranging then:
(P₂-P₁)=½D(V₁²-V₂²)
(P₂-P₁) therefore represents the maximum vacuum available to be used in the conversion of the kinetic energy available in a moving air mass or wind into usable mechanical or electrical energy.

The arrangement of vacuum generators 12, vacuum outlets 16 and secondary airflow accelerators 14 as illustrated in FIGS. 5 and 8 are preferred for reasons as previously described in detail in this section of the application. In summary, it is significant to the wind energy conversion efficiency of the present device that the relatively high speed flow of wind along the surfaces of vacuum generator 12 is unimpeded and that the wind flow remains laminar and attached to the aerodynamic surfaces as much as possible. The entrainment of air out of vacuum outlet 12 as illustrated by FIG. 7, and into this high speed wind flow will have the effect of decelerating the wind flow and of causing an early separation of the laminar wind flow from the aerodynamic surface of vacuum generator 12. This in turn will cause a dramatic loss of vacuum pressure and wind energy conversion efficiency of the device. The illustrations of FIGS. 5 and 8 show aerodynamic surfaces of secondary airflow accelerators 14 as having less camber or curvature than aerodynamic surfaces of the opposing vacuum generators 12. There are two principal results to this arrangement. Firstly, the location of vacuum outlet 16 on the less cambered surfaces of secondary airflow accelerator 14 has less a tendency to cause the laminar airflow along these surfaces to separate early and become turbulent as air exits vacuum outlet 16 and mixes with the wind flow passing through the venturi spacing. Secondly, and of equal importance, as airflow may be considered to function as thin layers of air sliding against itself, the airflow exiting vacuum outlet 16, when located a distance away from vacuum generator 12, is progressively accelerated by these sliding layers of air such that the higher speed layers of air immediately adjacent to the cambered surfaces of vacuum generator 12 suffer much less deceleration and much less separation as compared with the example of FIG. 7. Much as a slingshot gradually accelerates its projectile, so does this arrangement of vacuum generator 12, vacuum outlet 16 and secondary airflow accelerator 14 more gradually draws and accelerates the air from vacuum outlet 16 into the wind flow within the venturi spacing. A further ancillary advantage of the arrangement of components suggested by FIGS. 5 and 8 is the fact that a single vacuum channel 22 provides air to twice the number of vacuum outlets 16 as compared with the arrangement suggested by FIGS. 4 and 7. Having provided this description of the fundamental energy conversion of invention 10, it is now possible to provide a more comprehensive description of its operation.

Wind flow passing between the multiple narrowing venturi spacings will develop a lower static air pressure or vacuum relative to the ambient static pressure of the wind. This relative lower static air pressure will cause air to be drawn out of vacuum outlets 16 and mix with the wind flow between the venturi spacings. The wind flow between the venturi spacings will be first accelerated as the spacings narrow and then decelerated as the venturi spacings again widen out and the wind flow exits the venturi spacings to join the wind flowing around invention 10. Air drawn out of vacuum outlet 16 will also proceed from flow regulator 18 and past flow regulator valves 20. Flow regulator 18 provides a means to convey air from a source, or sources common to vacuum outlets 16. Flow regulator valves 20 provide a means to regulate the flow of air drawn through vacuum outlets 16 and specifically prevent or reduce a reverse flow of air into vacuum outlets 16. One embodiment of flow regulator valve 20, as illustrated by FIG. 6, is a panel, hinged to open out and in the direction of the flow of air drawn through vacuum outlet 16. When conditions exist where the static air pressure differentials reverse such that the static air pressure within one or more of flow regulator 18 is momentarily lower that that outside of the corresponding vacuum outlet 16 and within the venturi spacing, the hinged panel or panel embodiment of flow regulator valve 20 will hinge closed thus preventing or terminating the reverse flow of air into vacuum outlet 16. Should this effect not be prevented by flow regulator valve 20, a vacuum loss would result impairing the efficient conversion of energy by invention 10. As the natural flow of wind is characteristically turbulent, varying in velocity and direction, especially near to the ground, the flow of wind through the array of venturi spacings will also have varying velocities and produce different static air pressures in the vicinity of their respective vacuum outlets 16 and as well between interconnected vacuum outlets 16 of other venturi spacings. The hinged panel embodiments of flow regulator valves 20 may close by gravity, by return springs, by reverse airflow and reverse static pressure differential, by the electronic sensing of same, or by other means that will be recognized by those skilled in the art of such mechanical or electrical design. Such control of airflow provided by flow regulator valve 20 allows invention 10 to function efficiently in the erratic and turbulent conditions that are common to natural wind flow in relative proximity to the ground. Vacuum channels 22 therefore provide a means to convey air drawn out of vacuum outlets 16 from vacuum collector 24, itself a means to collectively supply air to the individual vacuum channels 22. Embodiments of vacuum channels 22 are illustrated by joined pipes with a significantly larger diameter pipe illustrated for vacuum collector 24 used to supply multiple vacuum channels 22 and minimize loss of vacuum pressure. Vacuum collector 24 in turn connects to energy converters 28 which utilize the flow of air drawn though energy converters 28 and drawn out of the array of vacuum outlets 16. The embodiment of energy converter 28 as illustrated by FIG. 3 consists of a turbine and electric generator or alternator as well as a housing for mounting of same, the housing additionally serving to provide a flow of air into and out of energy converter 28. This flow of air is drawn by vacuum pressure induced by vacuum generators 12, or by secondary airflow accelerators 14, which may have a similar function, and preferably by ram air provided by intake collectors 26. This illustrated embodiment of energy converter 28 is used to demonstrate one possible means for converting vacuum or ram air by energy converter 28, into usable mechanical or electrical energy. Other means for energy converter 28 will as well be recognized by those skilled in the art. A means for supplying airflow into energy converter 28 is facilitated by intake channel 30 such as an elbowed pipe as illustrated by FIG. 3. Intake collector 26 therefore serves to provide air into intake channel 30, into energy converter 28 and ultimately out of individual vacuum outlets 16. The illustrated means for intake collector 26 is a ram, or scoop, that in a preferred embodiment of invention 10, serves to provide a ram source of intake air ultimately into the areas of lower static air pressure within the venturi spacings of invention 10. It is not essential for the operation of invention 10 that ram air be provided by intake collector 26 however it is preferred where most or all of the elements of invention 10 are integrated into a single structure. It is also preferable to locate intake collectors 26, as illustrated by FIG. 1, on either ends of the array of vacuum generators 12 to facilitate self-orientation of invention 10 into the oncoming wind flow. It is the combination of intake collectors 26, intake channels 30, vacuum collectors 24, vacuum channels 22, flow regulators 18, flow regulator valves 20, vacuum outlets 16 and the flow of wind past vacuum generators 12 or secondary airflow accelerators 14 that constitute the ‘pneumatic transmission’ of invention 10. This pneumatic transmission, in addition to applying the multiple sources of air drawn by the venturi spacings of invention 10 onto a relatively small number of energy converters 28, serves to buffer the turbulence usually associated with wind flows near the ground so as to provide a more constant flow of air drawn through energy converters 28. This smoother and more controlled flow of air through energy converters 28 provides a longer life of the bearings and mechanisms of energy converters 28 and quieter operation.

Framework 32 provides a means to integrate elements of invention 10 into a single structure. Framework 32 as well preferably includes panels to enclose the top and bottom ends of the venturi spacings desirable to maintain a horizontal flow of wind through the venturi spacings. Embodiments of framework 32 as illustrated include welded metal box tubings used to integrate and support elements of invention 10. A placement of components of one embodiment of invention 10 and an overall aerodynamic shaping of framework 32 causes invention 10 to self-orient appropriately into the wind. Directional pivot 36 is also indicated and provides one means, such as a thrust bearing, that will allow invention 10 to turn into the oncoming wind solely by the reaction of the prevailing wind with the placement of components and overall aerodynamic shaping of invention 10. Directional pivot 36 may as well include a commuting plate for transmission of electrical current from energy converters 28 down to ground level for processing, storage or transmission. Riser 38 such as a mounting column for direction pivot 36 provides a means to raise the array of elements of invention 10 as supported by framework 32 clear of the turbulent and slower wind flows close to the ground. Foundation 40 is a means to support riser 38 suitably designed to support the structures of invention 10 in the most severe conditions of wind and weather as may be anticipated for the particular location of installation.

Continued operation in high speed winds that would necessitate the shut-down of rotor or vertical-axis wind energy converters is a particular object and advantage of the present invention. Conditions may occur where wind speeds could exceed even the electrical or mechanical limits of the present invention and in particular, the limits of energy converters 28. In rotor type or vertical-axis wind energy conversion systems brakes are generally used to limit the rotor or turbine speeds. The use of such brakes in the present invention is considered generally unnecessary as energy converters 28 may be smaller and therefore have lower forces acting on the turbine bearings. As well, as previously described, the pneumatic transmission inherent to invention 10 has the effect of reducing sudden loading of the turbine surfaces within energy converters 28. The use of over-vacuum relief valves located strategically on vacuum collector 24, intake channels 30 or incorporated within energy converters 28 is anticipated by invention 10 and not presently considered as novel.

The preceding descriptions serve to explain the main objects and advantages of invention 10. The scope of the invention however should not be determined by the embodiments, as described or illustrated, but by the appended claims and their legal equivalents.

1. A vacuum driven wind energy conversion invention comprising one or more vacuum generators, said vacuum generators having aerodynamic surfaces for accelerating the flow of wind and thereby inducing regions of vacuum; one or more vacuum outlets located in proximity to the said regions of vacuum that provide a source of air to be drawn into said regions of vacuum; one or more energy converters to convert the force of said air drawn into the said regions of vacuum into usable electrical or mechanical energy; one or more intake collectors to supply a source of said air or ram air to the said energy converters; one or more vacuum channels for supplying said air to said one or more vacuum outlets and to said one or more regions of vacuum, and for conveying said air from said energy converters; and a framework fashioned to support and integrate elements of said invention into a single structure and a mounting and arrangement of said elements of said invention on said framework such that the force of wind acting on the elements or on the framework causes the framework and elements to orient appropriately into the oncoming wind.

2. A vacuum driven wind energy conversion invention comprising one or more vacuum generators, said vacuum generators having aerodynamic surfaces for accelerating the flow of wind and thereby inducing regions of vacuum; one or more vacuum outlets located in proximity to the said regions of vacuum that provide a source of air to be drawn into said regions of vacuum; one or more energy converters to convert the force of said air drawn into the said regions of vacuum into usable electrical or mechanical energy; one or more intake collectors to supply a source of said air or ram air to the said energy converters; one or more vacuum channels for supplying said air to said one or more vacuum outlets and to said one or more regions of vacuum, and for conveying said air from said energy converters; and one or more flow regulator valves used to prevent or reduce a reverse flow of air into, rather than out of one or more said vacuum outlets that may otherwise occur under turbulent conditions of said wind flow, or to manage, limit or otherwise control the flow of air outwards from the said vacuum outlets and into the said regions of vacuum.

3. A vacuum driven wind energy conversion invention comprising one or more vacuum generators, said vacuum generators having aerodynamic surfaces for accelerating the flow of wind and thereby inducing regions of vacuum; one or more vacuum outlets located in proximity to the said regions of vacuum that provide a source of air to be drawn into said regions of vacuum; one or more energy converters to convert the force of said air drawn into the said regions of vacuum into usable electrical or mechanical energy; one or more intake collectors to supply a source of said air or ram air to the said energy converters; one or more vacuum channels for supplying said air to said one or more vacuum outlets and to said one or more regions of vacuum, and for conveying said air from said energy converters; and having a venturi design that includes one or more secondary airflow accelerators formed around one or more said vacuum outlets and having aerodynamic surfaces such that said wind flowing around said aerodynamic surfaces of said secondary airflow accelerators will be accelerated to a lesser degree than that of said wind flowing around the aerodynamic surfaces of an adjacent said vacuum generator, the two forming a venturi spacing through which said wind flows.

4. A vacuum driven wind energy conversion invention comprising one or more vacuum generators, said vacuum generators having aerodynamic surfaces for accelerating the flow of wind and thereby inducing regions of vacuum; one or more vacuum outlets located in proximity to the said regions of vacuum that provide a source of air to be drawn into said regions of vacuum; one or more energy converters to convert the force of said air drawn into the said regions of vacuum into usable electrical or mechanical energy; one or more intake collectors to supply a source of said air or ram air to the said energy converters; one or more vacuum channels for supplying said air to said one or more vacuum outlets and to said one or more regions of vacuum, and for conveying said air from said energy converters; a framework fashioned to support and integrate elements of said invention into a single structure and a mounting and arrangement of said elements of said invention on said framework such that the force of wind acting on the elements or on the framework causes the framework and elements to orient appropriately into the oncoming wind; and one or more flow regulator valves used to prevent or reduce a reverse flow of air into, rather than out of one or more said vacuum outlets that may otherwise occur under turbulent conditions of said wind flow, or to manage, limit or otherwise control the flow of air outwards from the said vacuum outlets and into the said regions of vacuum.

5. A vacuum driven wind energy conversion invention comprising one or more vacuum generators, said vacuum generators having aerodynamic surfaces for accelerating the flow of wind and thereby inducing regions of vacuum; one or more vacuum outlets located in proximity to the said regions of vacuum that provide a source of air to be drawn into said regions of vacuum; one or more energy converters to convert the force of said air drawn into the said regions of vacuum into usable electrical or mechanical energy; one or more intake collectors to supply a source of said air or ram air to the said energy converters; one or more vacuum channels for supplying said air to said one or more vacuum outlets and to said one or more regions of vacuum, and for conveying said air from said energy converters; and a framework fashioned to support and integrate elements of said invention into a single structure and a mounting and arrangement of said elements of said invention on said framework such that the force of wind acting on the elements or on the framework causes the framework and elements to orient appropriately into the oncoming wind; and having a venturi design that includes one or more secondary airflow accelerators formed around one or more said vacuum outlets and having aerodynamic surfaces such that said wind flowing around said aerodynamic surfaces of said secondary airflow accelerators will be accelerated to a lesser degree than that of said wind flowing around the aerodynamic surfaces of an adjacent said vacuum generator, the two forming a venturi spacing through which said wind flows.

6. A vacuum driven wind energy conversion invention comprising one or more vacuum generators, said vacuum generators having aerodynamic surfaces for accelerating the flow of wind and thereby inducing regions of vacuum; one or more vacuum outlets located in proximity to the said regions of vacuum that provide a source of air to be drawn into said regions of vacuum; one or more energy converters to convert the force of said air drawn into the said regions of vacuum into usable electrical or mechanical energy; one or more intake collectors to supply a source of said air or ram air to the said energy converters; one or more vacuum channels for supplying said air to said one or more vacuum outlets and to said one or more regions of vacuum, and for conveying said air from said energy converters; one or more flow regulator valves used to prevent or reduce a reverse flow of air into, rather than out of one or more said vacuum outlets that may otherwise occur under turbulent conditions of said wind flow, or to manage, limit or otherwise control the flow of air outwards from the said vacuum outlets and into the said regions of vacuum; and having a venturi design that includes one or more secondary airflow accelerators formed around one or more said vacuum outlets and having aerodynamic surfaces such that said wind flowing around said aerodynamic surfaces of said secondary airflow accelerators will be accelerated to a lesser degree than that of said wind flowing around the aerodynamic surfaces of an adjacent said vacuum generator, the two forming a venturi spacing through which said wind flows.

7. A vacuum driven wind energy conversion invention comprising one or more vacuum generators, said vacuum generators having aerodynamic surfaces for accelerating the flow of wind and thereby inducing regions of vacuum; one or more vacuum outlets located in proximity to the said regions of vacuum that provide a source of air to be drawn into said regions of vacuum; one or more energy converters to convert the force of said air drawn into the said regions of vacuum into usable electrical or mechanical energy; one or more intake collectors to supply a source of said air or ram air to the said energy converters; one or more vacuum channels for supplying said air to said one or more vacuum outlets and to said one or more regions of vacuum, and for conveying said air from said energy converters; a framework fashioned to support and integrate elements of said invention into a single structure and a mounting and arrangement of said elements of said invention on said framework such that the force of wind acting on the elements or on the framework causes the framework and elements to orient appropriately into the oncoming wind; one or more flow regulator valves used to prevent or reduce a reverse flow of air into, rather than out of one or more said vacuum outlets that may otherwise occur under turbulent conditions of said wind flow, or to manage, limit or otherwise control the flow of air outwards from the said vacuum outlets and into the said regions of vacuum; and having a venturi design that includes one or more secondary airflow accelerators formed around one or more said vacuum outlets and having aerodynamic surfaces such that said wind flowing around said aerodynamic surfaces of said secondary airflow accelerators will be accelerated to a lesser degree than that of said wind flowing around the aerodynamic surfaces of an adjacent said vacuum generator, the two forming a venturi spacing through which said wind flows.

8. A method for using wind energy, comprising:
providing a number of components including at least a first vacuum generator that accelerates wind passing over aerodynamic surfaces of said first vacuum generator and induces one or more regions of vacuum and at least a first vacuum outlet positioned in proximity to said one or more regions of vacuum which acts as an outlet and source of air to be drawn into said one or more regions of vacuum;
reducing reverse flow of air into, rather than out of, said at least first vacuum outlet; and
converting airflow drawn into said one or more regions of vacuum into usable electrical or mechanical energy using an energy converter.

9. The method of claim 8 further comprising receiving ram air into said energy converter using at least a first intake collector.

10. The method of claim 8 wherein said number of components are combined by a framework that supports and integrates said components into a single structure and in which said components are mounted and arranged such that the force of the wind causes said framework and said components to orient into the wind.

11. The method of claim 8 further comprising accelerating secondary airflow using at least a first secondary airflow accelerator associated with said first vacuum outlet and in which said first secondary airflow accelerator accelerates wind to a lesser degree than wind flowing around said aerodynamic surfaces of said first vacuum generator.

12. The method of claim 8 wherein said reducing is conducted using one or more flow regulator valves.

13. A method for using wind energy, comprising:
providing a number of components including at least a first vacuum generator that accelerates wind passing over aerodynamic surfaces of said first vacuum generator and that induces one or more regions of vacuum and at least a first vacuum outlet positioned in proximity to said one or more regions of vacuum that acts as an outlet and a source of air to be drawn into said one or more regions of vacuum;
accelerating secondary airflow using at least a first secondary airflow accelerator associated with said first vacuum outlet and in which wind flowing around said secondary airflow accelerator is accelerated to a lesser degree than that of wind flowing around said aerodynamic surfaces of said first vacuum generator; and
converting airflow drawn into said one or more regions of vacuum into usable electrical or mechanical energy.
